(19) United States
(12) Patent Application Publication
(10) Pub. No.: US 2007/0075036 A1
(43) Pub. Date: Apr. 5, 2007

(54) Method and apparatus for measuring plasma density in processing reactors using a short dielectric cap

(76) Inventor: Paul Moroz, Marblehead, MA (US)

Correspondence Address: Dale S. Lazar;DLA Piper Rudnick Gray Cary US LLP, Post Office Box 9271, Reston, VA, 20195, US

(21) Appl. No.: 11/239,472

(22) Filed: Sep. 30, 2005

(51) Int. Cl. G01L 21/30

(52) U.S. Cl. 216/59; 216/67

(57) ABSTRACT

An apparatus for measuring plasma density of a plasma processing reactor, comprises a stationary compact probe having a short dielectric cap with a short coaxial cable inserted therein and having an open metal antenna tip. The probe can be utilized to determine resonant plasma frequency near its tip location. Two or more of such probes can be used to determine three dimensional plasma density distribution inside the plasma processing reactor.

This application is related to patent application attorney's docket number 313530-P00012 entitled “Method and Apparatus for Measuring Plasma Density in Processing Reactors using a Long Dielectric Tube”, filed concurrently herewith, the contents of which are incorporated herein in their entirety.

### FIELD OF THE INVENTION

The present invention relates generally to measuring plasma density, and relates specifically to measuring plasma density in plasma processing reactors.

### BRIEF DESCRIPTION OF THE DRAWINGS

FIG. 1 is a schematic representation of a probe, according to one embodiment of the invention.

FIGS. 2-3 illustrate a probe utilizing an element that keeps distance constancy, according to one embodiment of the invention.

FIG. 4 illustrates a probe with an alternative dielectric cap shape, according to one embodiment of the invention.

FIGS. 5-6 illustrate a probe with alternative antenna tip shapes, according to embodiments of the invention.

FIGS. 7-8 are schematic representations illustrating multiple probes 101 embedded in the substrate holder, according to one embodiment of the invention.

FIGS. 9-10 are schematic representations illustrating multiple probes 101 mounted on the inner side of the walls of processing chamber, according to one embodiment of the invention.

FIGS. 11-12 are schematic representations illustrating multiple probes located on the periphery of the substrate holder, according to one embodiment of the invention.

FIG. 13 is a graph illustrating resonance frequencies ω/ωₚ versus tip distance in the m=1 mode, according to one embodiment of the invention.

### DESCRIPTION OF EMBODIMENTS OF THE INVENTION

Apparatus for Measuring Plasma Density

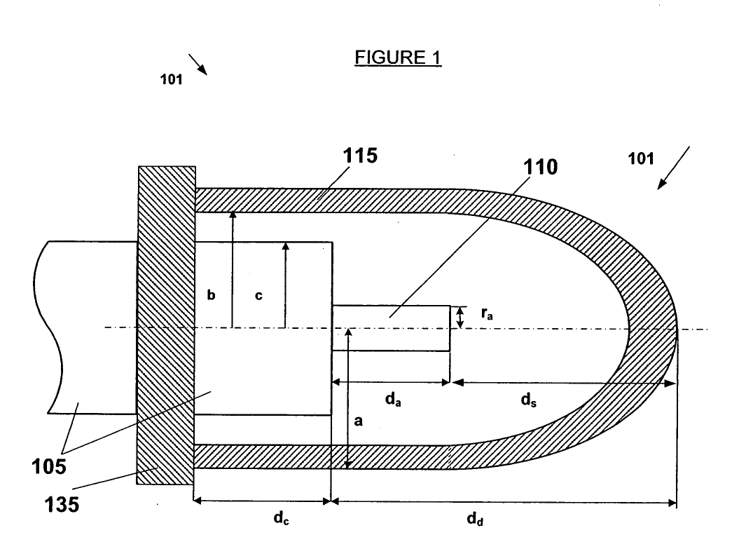

FIG. 1 is a schematic representation of a probe 101 for measuring the density of a plasma, according to one embodiment of the invention. Plasma is used in material processing reactors because it has significant advantages in processing rate, accuracy, and processing capabilities over non-plasma methods. Plasma density defines the radical content in the processing gas and the processing speed, and is important for a process engineer to know. Plasma density in a processing chamber depends on many factors, including gas composition, gas pressure, flow rate, RF power, pumping speed, geometry of the chamber, and the materials of the chamber walls and the electrodes. Plasma density in a processing chamber also depends on the power of ionizing sources, which is typically radio frequency (RF) power applied from various types of coils (i.e., inductively coupled plasma sources, or ICP), RF power applied to electrodes (i.e., capacitive coupled plasma sources, or CCP), microwave power, etc. Furthermore, plasma density in the processing chamber depends on the rate of loss of the plasma due to, for example, direct loss to the walls, the electrodes, and various recombination and neutralization processes.

In FIG. 1, the probe 101 comprises a coaxial cable 105 with an open antenna tip 110, surrounded by a short dielectric cap 115. The coaxial cable 105 goes through the metal base 135 (which can, for example, comprise any metal elements of the surrounding structures, such as, for example, the processing chamber wall or a substrate holder). In one embodiment, the part of the cable located within the dielectric cap 115 is short. For example, the length of the coaxial cable located within the dielectric cap is less than the length of the antenna tip 110. The coaxial cable 105 is a round cable comprising, from the center outwards, a center wire, a dielectric layer, a braided metal mesh sleeve, and an outer shield. The shield prevents signals transmitted on the center wire from affecting nearby components and prevents external interference from affecting the signal carried on the antenna.

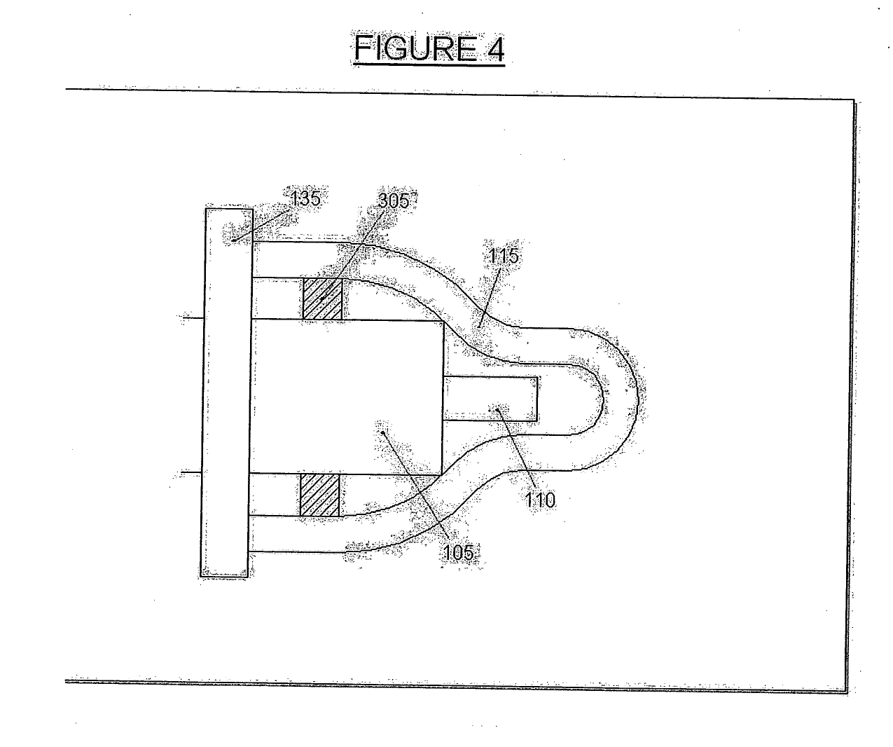

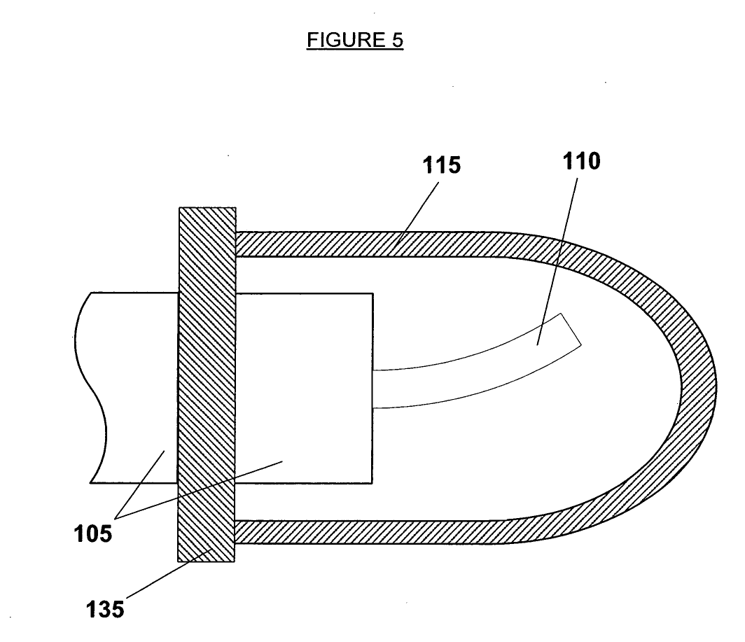

In the embodiment of FIG. 1, the center wire extends out beyond the other layers to form open antenna tip 110. The antenna tip 110 can be a naked metal wire at least a few millimeters long. The antenna tip 110 can be straight or not straight. As examples of antenna tips 110 that are not straight, see FIGS. 4 and 5, illustrating an antenna tip 110 bent in one direction, and an antenna tip 110 bent in the shape of a partial loop, respectively.

The dielectric cap 115 isolates the coaxial cable 105 and the antenna tip 110 from the plasma and prevents direct currents on the coaxial cable 105 and the antenna tip 110. In one embodiment, there is a space of at least a few millimeters between the antenna tip 110 and the dielectric cap 115. The material of the dielectric cap 115 can be selected to adjust resonant frequency for the system. The dielectric permittivity of the material of the dielectric cap 115 can thus be chosen to correspond to an expected plasma density range (e.g., quartz has a lower dielectric permittivity than ceramic). The resonant frequency increases with increasing plasma density (approximately, as square root of density) and decreasing dielectric permittivity of the cap. Thus, when high plasma density is expected, a material having a higher dielectric permittivity can be used to keep the resonant frequency within the range of a network analyzer, which, in one embodiment is below about 5 GHz. Possible dielectric depositions on the dielectric cap 115 in a chemically active environment do not affect the probe data, at least until the thickness of the deposition layer becomes thick enough to be comparable with the thickness of the dielectric cap 115. The tip of the dielectric cap 115 is located within the area where the plasma density is to be measured.

In one embodiment, the probe 101 comprises a very short dielectric cap 115 and, correspondingly, a short coaxial cable 105 located within the short dielectric cap. The probe 101 can be used as a convenient diagnostic tool in all plasma processing operations to detect plasma properties proximate to the base 135 of the probe 101. Because the dielectric cap 115 and coaxial cable 105 are short, they do not disturb the plasma as long dielectric caps or coaxial cables might. In addition, because the probe 101 is compact, it can be permanently installed within the processing chamber without disturbing the processing plasma and/or other processing parameters. In addition, the probe 101 is designed such that plasma facing materials, on one hand, can withstand the high temperature and heat fluxes from the plasma, and on the other hand, do not contribute polluting components back into the plasma and into the processing environment.

A base 135 closes the probe 101 and connects the probe to a component of the plasma processing chamber. The base 135 can be made of, for example, metal (e.g., aluminum). If the probe 101 is embedded in some other structure (e.g., the substrate holder or a vacuum chamber wall, which can be metal), then the base 135 might be absent because the body of the substrate holder or vacuum chamber wall will be the base 135. A vacuum seal can be included in base 135 to seal the probe 101.

FIG. 1 illustrates geometrical parameters of a probe 101, according to one embodiment of the invention. The external radius of the dielectric cap 115 is a. The internal radius of the dielectric cap 115 is b. The horizontal distance between the coaxial cable end and the dielectric cap end is d_{d}. The external radius of the coaxial cable 105 is c. The horizontal distance of the coaxial cable 105 inside the dielectric cap 115 is d_{c}. The radius of the antenna tip 110 is rₐ. The horizontal distance between the coaxial cable end and the antenna tip end is dₐ. The horizontal distance (i.e., the space) between the external radius of the dielectric cap 115 and the antenna tip 110 is dₛ. These geometrical parameters of the probe define its resonant characteristics.

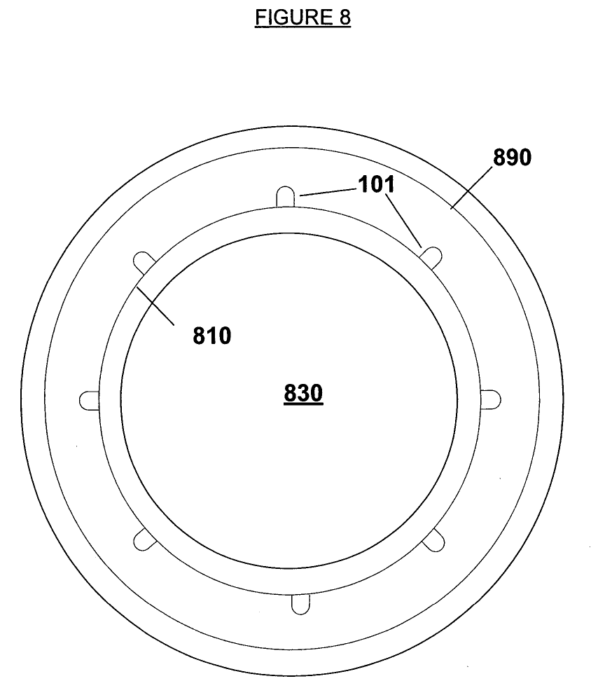

It is often beneficial to add elements (e.g., spacers, in-and-out feature), change elements (e.g., antenna shape), or add additional probes 101 to improve the sharpness of the absorption resonances (as shown in FIG. 8), compensate for the possible geometry modification due to heat fluxes on the probe 101 from the plasma or other sources, or gain additional information about the plasma density.

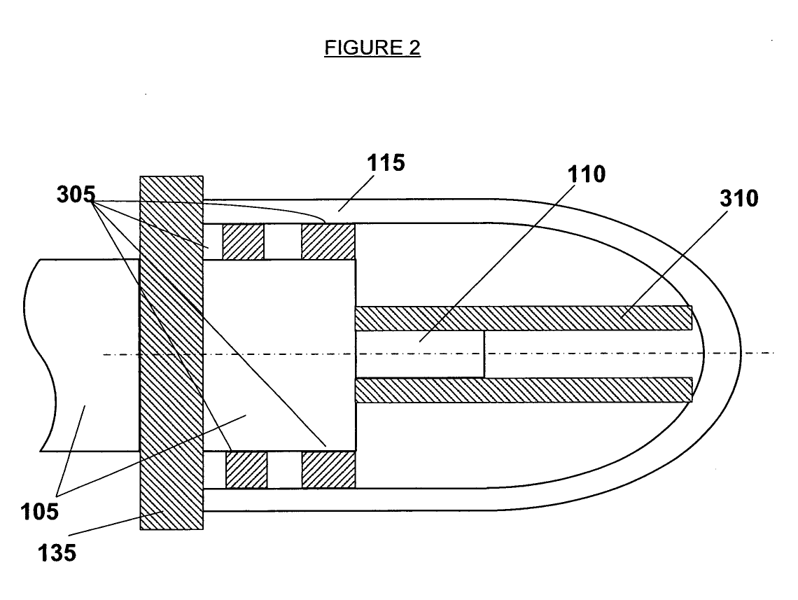

Spacers. FIG. 2 illustrates a probe 101 utilizing an element that keeps distance constancy, according to one embodiment of the invention. The distance constancy reduces any change in the resonant frequency over time as a result of the heating of the probe due to particle and heat fluxes from the plasma. In one embodiment, a spacer can be used to keep distance constancy. The spacers can be placed inside the dielectric cap 115 around the antenna tip 110 and/or the coaxial cable 105. The external radius of the antenna tip 110 and/or the coaxial cable 105 can be chosen to be smaller than the internal radius of the dielectric cap 115. This distance helps in reducing the heating of the cable 105 and the antenna 110, and thus positively contributes to the life-time of the probe. At the same time, in one embodiment, this distance should not be too large because it can reduce the sensitivity of the probe to the surface waves running along the plasma edge of the dielectric cap. The spacers can be in the forms of tubes or rings. The spacers can be made of a dielectric material or of a metal material.

Spacers around the antenna tip 110 can be tubes 310, and can be made of a dielectric material to ensure relative constancy of the distance dₛ between the antenna tip and the end of the dielectric cap, in spite of possible thermal expansions of the coaxial cable 105. In addition, spacers around the antenna tip 110 ensure relative constancy of the antenna tip shape (e.g., staying straight and not being bent under varying thermal conditions).

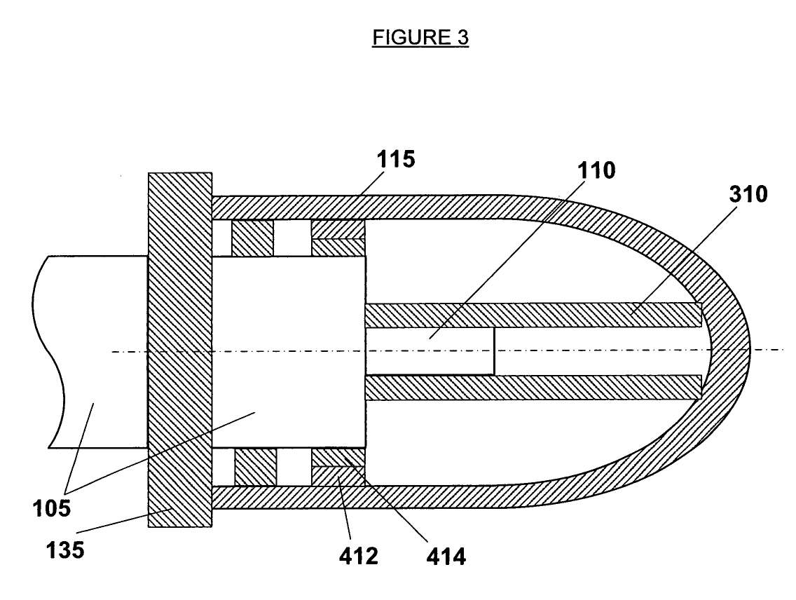

To fix the coaxial cable 105 inside the dielectric cap 115, spacers can be provided between the coaxial cable 105 and the dielectric cap 115. These spacers can be in the form of tubes or rings 305. Spacers between the coaxial cable 105 and the dielectric cap 115 can be of a dielectric material, metal material, or a combination of a dielectric material with a metal material, as illustrated by dielectric spacer 412 and metal spacer 414 in FIG. 3. The dielectric spacer fixes the cable end at a specified position. The metal spacer provides a sharp reflecting boundary for the plasma surface waves, so the plasma absorption resonances are more clearly pronounced and measured.

FIG. 4 illustrates a probe 101 with a dielectric cap 115 in an alternate shape, according to one embodiment of the invention. Spacers around the antenna tip 110 can be replaced by a dielectric cap of a special shape which limits cable expansion and ensures a relative constancy of the antenna tip distance, d_{d}. In one embodiment, the corner of coaxial cable 105 abuts against dielectric tube 115 and antenna tip 110 extends into a portion of dielectric tube 115 with reduced diameter. With this particular shape, probe 101 is highly sensitive to the plasma because the radial distance between the antenna tip 110 and the external surface of the dielectric cap 115 is short. The heat transfer to the antenna tip 110 increases, and thus, this type of a probe can be used in a low power discharges with relatively low heat fluxes.

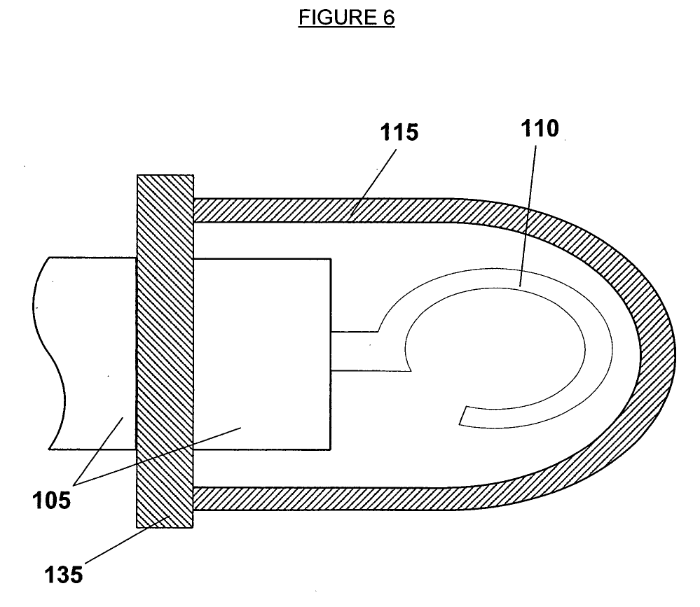

Alternate Antenna Shapes. FIGS. 5-6 illustrate a probe 101 with alternative antenna tip shapes, according to embodiments of the invention. The alternative antenna tip shapes can be used with certain modes of resonance, corresponding to various standing wave patterns of the electromagnetic field caused by the interaction of the probe with the plasma. For example, in mode m=0, the intensity is constant within a plane perpendicular to the center conductor at a constant distance from the center conductor. In mode m=1, the intensity has one maximum and one minimum in the plane at a constant distance from the center conductor. In mode m=2, the intensity has two maximums and two minimums in the plane at a constant distance from the center conductor.

A probe 101 with a straight antenna tip 110, as shown in FIG. 1, is beneficial for picking up the main m=0 mode of the plasma surface waves. However, other modes can be of importance as well. FIG. 5 illustrates a probe 101 with the antenna tip bent on one side, which picks up the m=1 mode of the plasma surface waves. FIG. 5 6 illustrates a probe 101 with the antenna tip the shape of a partial loop, which picks up the m=2 mode of the plasma surface waves.

Multiple Probes. A single probe 101 can provide information on the local plasma density at a particular location inside the plasma processing reactor. Multiple probes 101 can also be utilized to determine plasma density distribution inside the plasma processing reactor. Information about the density of the plasma around the probe or probes can be collected and used along with a model of relative plasma densities within the plasma processing reactor to project the density of the plasma at other locations in the plasma processing reactor. The model can be derived from measurements or mathematical simulation. The probes 101 can be mounted on or embedded into plasma-facing components in the processing chamber 130 to provide information on the local values of the plasma density near the probes' locations. The probes 101 can be embedded in horizontal, vertical and other positions. The probes 101 can also be located symmetrically about the plasma processing reactor.

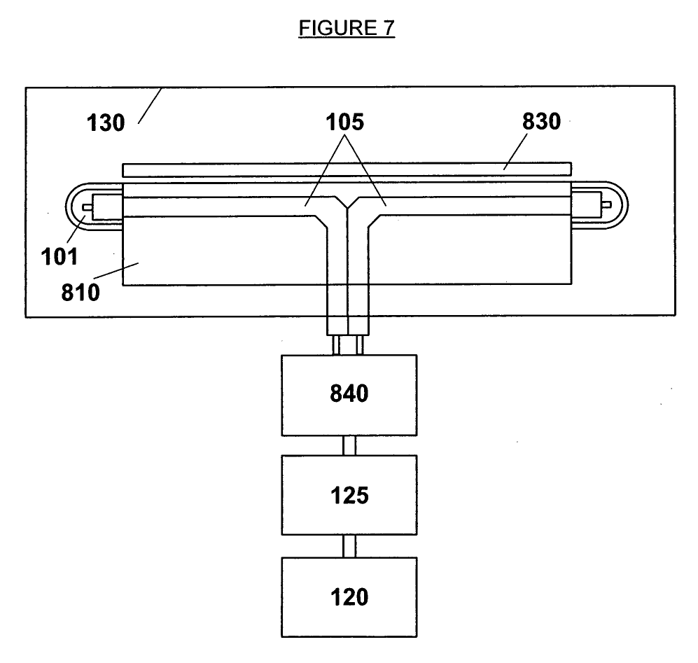

FIG. 7 is a schematic representation illustrating multiple probes 101 embedded horizontally in the substrate holder 810, according to one embodiment of the invention. In this embodiment, probes 101 are embedded in the elements of the apparatus in direct contact with the plasma. The probes 101 are capable of continuously supplying information on plasma density during materials processing procedures, and are able to provide information on plasma non-uniformity. The probes 101 can be used in various plasma reactor environments, including the ICP, CCP, or microwave environments.

Referring to FIG. 7, the substrate or wafer 830 is located on the substrate holder and is typically attached to it by electrostatic or mechanical clamping. The coaxial cable (or a few coaxial cables) 105 runs from the probes 101 to a high-frequency switch 840 capable of fast switching between its multi-channel inputs, so the signal from each coaxial cable 105 can be taken in. If there is only a single probe 101 installed in the apparatus, then the switch 840 is not required. The switch 840 (when it is present) connects the coaxial cable 105 to the High Pass Filter (HPF) 125, which reduces low frequency range signals, which are typically present in that environment because of the application of RF power and harmonic excitation in the plasma. The HPF 125 reduces the intensity of frequencies below those that are used for the measurements by the apparatus. For the typical plasma parameters used in the plasma processing reactors, all frequencies below approximately 500 MHz can be reduced by the HPF 125. The HPF 125 is connected to the network analyzer 120. The network analyzer 120 generates a signal at required frequencies, typically, above 1 GHz. The upper range of 2 to 3 GHz might suffice for low plasma density environments, while frequencies up to 4 to 5 GHz might be required for high plasma density environments. The network analyzer 120 generates a signal which is applied to coaxial cable 105 and measures the reflected signal coming back from the probe(s) 101 as described above. At particular resonant frequencies corresponding to excitation of localized surface waves at the plasma and dielectric-cap interface, the reflected signal will have a dip, which allows determination of the local plasma density at the location of the probe(s) 101.

FIG. 8 is a schematic representation presenting the top view of the embodiment where the probes 101 are embedded in the substrate holder 810, as depicted in FIG. 6. The probes 101 can be attached to a focus ring typically used in substrate holders or the body of the substrate holder 810. The substrate or wafer 830 is located on the substrate holder 810 and is typically attached to it by electrostatic or mechanical clamping. The processing chamber wall 890 surrounds the substrate holder 810.

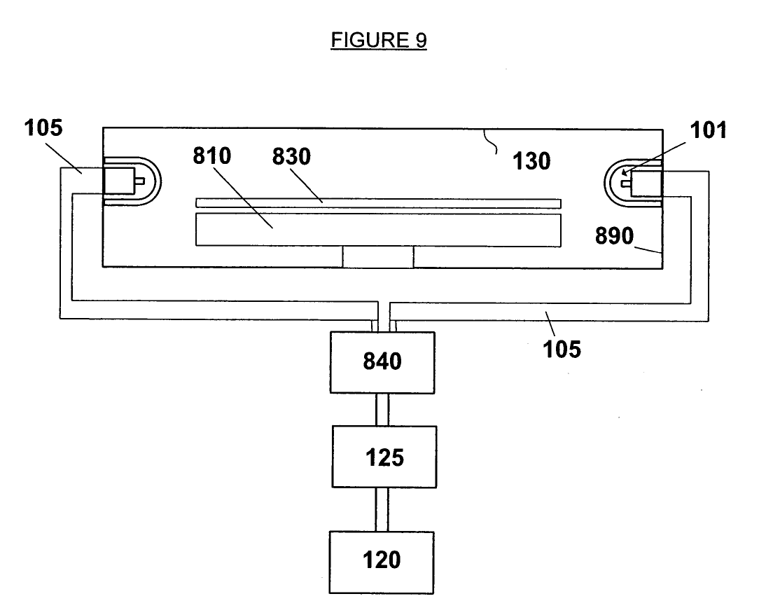

FIG. 9 is a schematic representation illustrating multiple probes 101 mounted on the inner side of the walls 890 of processing chamber 130, according to one embodiment of the invention. The substrate or wafer 830 is located on the substrate holder 810 and is typically attached to it by electrostatic or mechanical clamping. The coaxial cable (or a few coaxial cables) 105 runs from the probes 101 to a high-frequency switch 840 capable of fast switching between its multi-channel inputs, so the signal from each coaxial cable 105 can be taken in. If there is only a single probe 101 installed in the apparatus, then the switch 840 is not required. The switch 840 (when it is present) connects the coaxial cable 105 to the HPF 125, which cuts off the low frequency range signals. The HPF 125 reduces the frequencies below those that are used for the measurements by the apparatus. The HPF 125 is connected to the network analyzer 120. The network analyzer 120 generates a signal that is applied to coaxial cable 105 and measures the reflected signal coming back from the probe(s) 101 as described above. At particular resonant frequencies corresponding to excitation of localized surface waves at the plasma and dielectric-cap interface, the reflected signal will have a dip, which allows determination of the local plasma density at the location of the probe(s) 101.

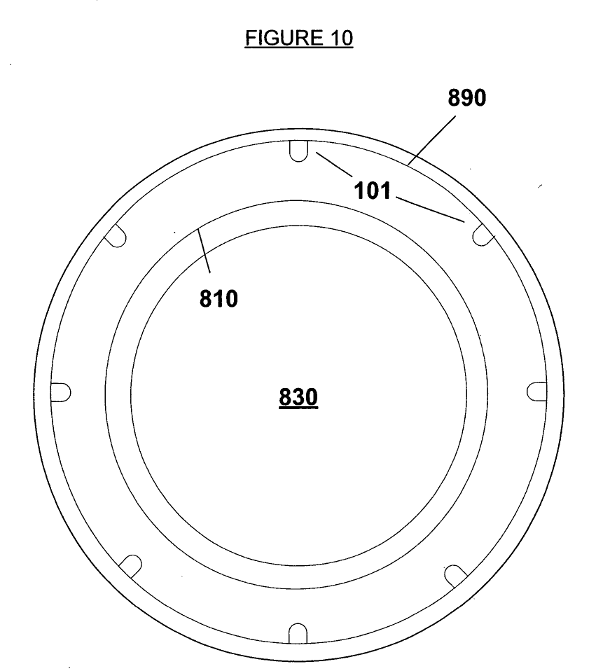

FIG. 10 is a schematic representation presenting the top view of the embodiment where the probes 101 are mounted on the vacuum chamber wall 890, as depicted in FIG. 9. The substrate or wafer 830 is located on the substrate holder 810 and is typically attached to it by electrostatic or mechanical clamping.

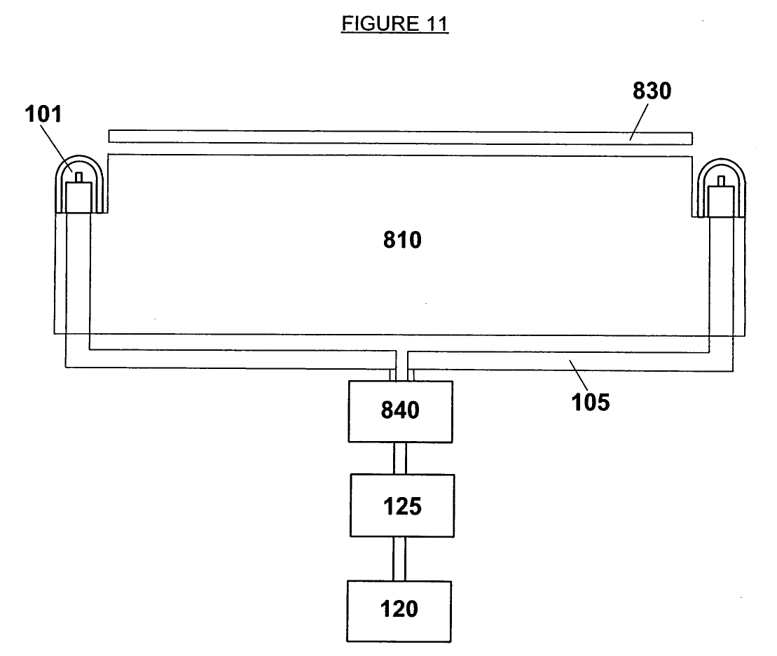

FIG. 11 is a schematic representation illustrating multiple probes 101 located vertically on the periphery of the substrate holder 810, according to one embodiment of the invention. The substrate or wafer 830 is located on the substrate holder 810 and is typically attached to it by electrostatic or mechanical clamping. The coaxial cable (or a few coaxial cables) 105 runs from the probes 101 to a high-frequency switch 840 capable of fast switching between its multi-channel inputs, so the signal from each coaxial cable 105 can be taken in. If there is only a single probe 101 installed in the apparatus, then the switch 840 is not required. The switch 840 (when it is present) connects the coaxial cable 105 to the HPF 125, which cuts off the low frequency range signals. The HPF 125 cuts the frequencies below those that are used for the measurements by the apparatus. The HPF 125 is connected to the network analyzer 120. The network analyzer 120 generates a signal which is applied to coaxial cable 105 and measures the reflected signal coming back from the probe(s) 101 as described above. At particular resonant frequencies corresponding to excitation of localized surface waves at the plasma and dielectric-cap interface, the reflected signal will have a dip, which allows determination of the local plasma density at the location of the probe(s) 101.

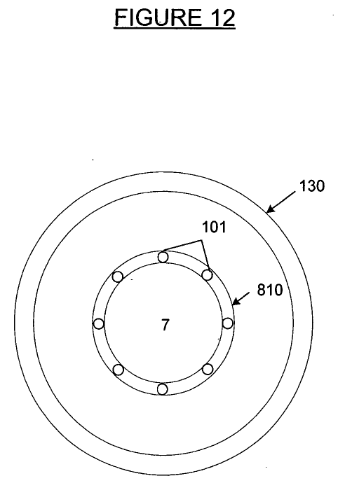

FIG. 12 is a schematic representation presenting the top view of the embodiment where the probes 101 are located on the periphery of the substrate holder 810, as depicted in FIG. 11. The probes 101 can be attached to a focus ring typically used in substrate holders or the body of the substrate holder 810. The substrate or wafer 830 is located on the substrate holder 810 and is typically attached to it by electrostatic or mechanical clamping.

When the probes 101 are mounted on the substrate holder and close to the wafer, the plasma density measurements by the probes 101 provide direct data on plasma density near the wafer. In the cases when the probes 101 are mounted on the processing chamber wall or on some other structural elements distanced from the wafer, the measurements could only provide information on plasma density near those places, and not near the wafer.

Method for Measuring Plasma Density

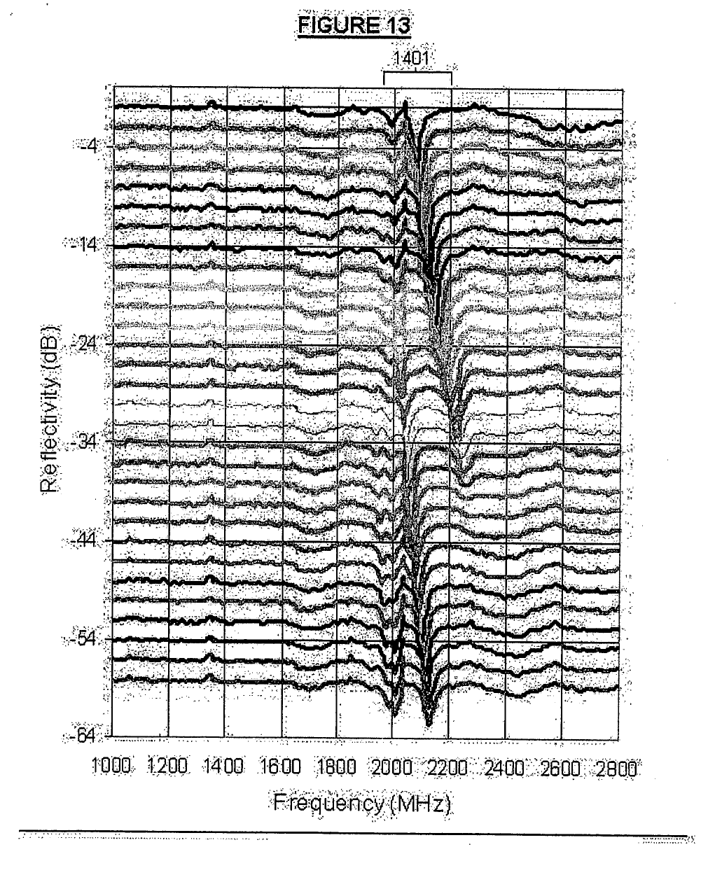

In use, the frequency or wavelength at which resonance occurs with each probe 101 is measured, which provides information needed to determine the plasma density. For example, FIG. 13 is a graph illustrating the change of resonance frequencies ω/ωₚ versus tip distance, according to one embodiment of the invention. The discontinuities 1401 on the graph identify the frequency at which resonance occurs. RF signals from the network analyzer 120 are reflected back to the network analyzer 120, providing the plasma wave resonance signature. The HPF 125 is located between the probe 101 and the network analyzer 120, and reduces strong low frequency signals which otherwise would penetrate from the plasma region. As an example, a cut off frequency for the HPF can be chosen to be a factor of 10 lower than the main RF power frequency. Once the low frequency signals are cut off, the network analyzer 120 can measure the frequency or wavelength at which resonance occurs, which is related to the plasma density.

In one embodiment, a method is provided to relate the observed resonances with the plasma density. Once the resonant frequency for the known wave mode is measured and the dielectric permittivity of the dielectric cap ε_{d} is known, the dielectric permittivity εₚ of the plasma is determined using the following dispersion relation:

$$D ( ω , {k}_{z} , m ) = {ɛ}_{p} - {ɛ}_{d} \cdot \frac{{K}_{m} ( {k}_{z} a )}{{K}_{m}^{′} ( {k}_{z} a )} \cdot \frac{α {I}_{m}^{′} ( {k}_{z} a ) + β {K}_{m}^{′} ( {k}_{z} a )}{α {I}_{m} ( {k}_{z} a ) + β {K}_{m} ( {k}_{z} a )} = 0 \qquad ( 1 )$$

where:

ω=2πf (where f is a wave frequency)

k_{z}=2π/λ (where k_{z} is a longitudinal wave vector; λ is a longitudinal wavelength)

m=azimuthal mode number

ε_{d}=dielectric permittivity of the dielectric cap 115

a=external radius of dielectric cap 115

b=internal radius of dielectric cap 115

Iₘ=modified Bessel function of first kind of order m

Kₘ=modified Bessel function of second kind of order m

Iₘ′ and Kₘ′ are derivatives, respectively, for Iₘ and Kₘ.

and

$$α = \frac{1}{{ɛ}_{d}} \cdot \frac{{sK}_{m} ( {k}_{z} b ) - p {ɛ}_{d} {K}_{m}^{′} ( {k}_{z} b )}{{K}_{m} ( {k}_{z} b ) {I}_{m}^{′} ( {k}_{z} b ) - {I}_{m} ( {k}_{z} b ) {K}_{m}^{′} ( {k}_{z} b )} \\ β = \frac{1}{{ɛ}_{d}} \cdot \frac{p {ɛ}_{ d} {I}_{m}^{′} ( {k}_{z} b ) - {sI}_{m} ( {k}_{z} b )}{{K}_{m} ( {k}_{z} b ) {I}_{m}^{′} ( {k}_{z} b ) - {I}_{m} ( {k}_{z} b ) {K}_{m}^{′} ( {k}_{z} b )} \qquad ( 2 )$$

Parameters s and p depend on the region of the probe, particularly the antenna region. They are given by the expressions:

$$\begin{matrix}p = {I}_{m} ( {k}_{z} b ) - \frac{{I}_{m} ( {k}_{z} {r}_{a} )}{{K}_{m} ( {k}_{z} {r}_{a} )} * {K}_{m} ( {k}_{z} b ) & ( 3 ) \\ s = {I}_{m}^{′} ( {k}_{z} b ) - \frac{{I}_{m} ( {k}_{z} {r}_{a} )}{{K}_{m} ( {k}_{z} {r}_{a} )} * {K}_{m}^{′} ( {k}_{z} b ) & ( 4 )\end{matrix}$$

where rₐ=radius of antenna tip

Once εₚ is known, the plasma frequency ωₚ is determined using the following formula:

$${ɛ}_{p} = 1 - \frac{{ω}_{p}^{2}}{{ω}^{2}} \qquad ( 5 )$$

Once the plasma frequency ωₚ is determined, the plasma density nₑ can be determined using the following relation:
ωₚ\sqrt{4·nₑe²/mₑ}≈5.64×10⁴\sqrt{nₑ}(6)

### CONCLUSION

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. In fact, after reading the above description, it will be apparent to one skilled in the relevant art(s) how to implement the invention in alternative embodiments. Thus, the present invention should not be limited by any of the above-described exemplary embodiments.

It should also be noted that when a claim refers to “a” component, this language also covers “at least one” of that component. If a claim refers to “a” probe, an invention that includes more than one probe would necessarily include “a” probe or “one” probe.

In addition, it should be understood that the figures, which highlight the functionality and advantages of the present invention, are presented for example purposes only. The architecture of the present invention is sufficiently flexible and configurable, such that it may be utilized in ways other than that shown in the accompanying figures.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope of the present invention in any way.

What is claimed is:

1. An apparatus for measuring density inside a plasma processing reactor, comprising:
a probe comprising a closed dielectric cap and a piece of coaxial cable inserted into the closed dielectric cap and having an open metal antenna tip, the coaxial cable being of a shorter length than the antenna tip, the probe being permanently located within a vacuum chamber of the plasma-processing reactor;
a coaxial cable connected to the probe;
a network analyzer supplying a high-frequency signal to the probe and measuring the intensity of the reflected signal; and
a high-pass filter located between the cable and the network analyzer to reduce low frequency signals.

2. The apparatus of claim 1, wherein the probe includes at least two probes, the apparatus further comprising a high frequency switch, the coaxial cable connecting the at least two probes with the high-frequency switch, and the high-pass filter being located between the high-frequency switch and the network analyzer.

3. The apparatus of claim 1, wherein the high-frequency signal is in the range of 0.5-5 GHz.

4. The apparatus of claim 1, wherein the antenna tip is a straight naked metal wire at least a few millimeters long, the antenna tip representing the center electrode of the coaxial cable stripped of isolation and metal screening.

5. The apparatus of claim 4, wherein an end of the antenna tip does not touch an inner end of the dielectric cap, so there is a space of at least a few millimeters between the antenna tip and the dielectric cap.

6. The apparatus of claim 5, wherein constancy of the space between the antenna tip and the dielectric cap is maintained, in spite of possible thermal expansion of the cable.

7. The apparatus of claim 6, wherein a dielectric spacer is disposed inside the dielectric cap around the antenna tip to provide constancy of the space between the antenna tip and the dielectric cap.

8. The apparatus of claim 7, wherein the dielectric spacer is a dielectric tube with inner radius approximately equal to the radius of the antenna tip to ensure constancy of the antenna tip shape.

9. The apparatus of claim 1, wherein the dielectric cap is made of material with a dielectric property used in correspondence with expected plasma density to produce a resonance in a frequency range of the network analyzer.

10. The apparatus of claim 9, wherein for measurements in the higher plasma density range, material with higher dielectric permittivity is chosen.

11. The apparatus of claim 1, further comprising the dielectric cap of the probe being located on one side of the base, and the high-frequency cable runs through the base and inside the probe and ends by the antenna tip.

12. The apparatus of claim 11, wherein the base is made of electrically conducting material.

13. The apparatus of claim 11, wherein the base is made of dielectric material.

14. The apparatus of claim 1, wherein the probe is disposed proximate to the structure of a plasma-facing component.

15. The apparatus of claim 1, wherein the probe has at least one ring inside the probe on the end of the cable, in radial direction between the cable and the cap.

16. The apparatus of claim 15, wherein the ring is made of electrically conducting material.

17. The apparatus of claim 15, wherein the ring is made of dielectric material.

18. The apparatus of claim 15, wherein the at least one ring includes at least two rings at the end of the cable, and one ring is made of an electrically conducting material and the other ring is made of a dielectric material.

19. The apparatus of claim 1, wherein the probe includes at least two probes located evenly and symmetrically around the substrate holder and embedded into the substrate holder and near the substrate.

20. The apparatus of claim 1, wherein the antenna tip of the probe is not straight but is bent in one direction.

21. The apparatus of claim 1, wherein the antenna tip of the probe is not straight but is bent in the shape of a partial loop.

22. A method for determining density of plasma in a plasma processing reactor, comprising:
measuring a resonant frequency of the plasma utilizing a probe;
determining the density of the plasma around the probe using the resonant plasma frequency;
determining the density of the plasma at other locations in the plasma processing reactor based on the density of the plasma around the probe and a model of relative plasma densities in the plasma processing reactor.

23. The method of claim 22, wherein at least two probes are used, and the density of the plasma at other locations is determined based on the density of the plasma around the probes.

24. An apparatus for determining density of plasma in a plasma processing reactor, comprising:
a probe comprising a short dielectric cap and a coaxial cable inserted in the short dielectric cap, the coaxial cable having an open antenna tip;
wherein the probe is located in an element of the plasma processing reactor in direct contact with plasma.

25. The apparatus of claim 24, wherein the probe is located within a substrate holder of the plasma processing reactor.

26. The apparatus of claim 24, wherein the probe is located on chamber walls of the plasma processing reactor.

27. The apparatus of claim 24, wherein the probe is located on a periphery of the substrate holder of the plasma processing reactor.

28. The apparatus of claim 24, wherein at least two probes are located symmetrically about the plasma processing reactor.

29. The apparatus of claim 28, wherein information about local values of the plasma density is provided by the probes and utilized to determine three dimensional plasma density distribution inside the plasma processing reactor.

30. The apparatus of claim 24, further comprising a network analyzer coupled to the probe through the coaxial cable.

31. The apparatus of claim 30, wherein the network analyzer supplies a high-frequency signal to the probe and measures intensity of a reflected signal.

32. The apparatus of claim 31, further comprising an additional probe and a high pass filter located between each probe and the network analyzer, the high-pass filter reducing low frequency signals.

33. A method for determining density of plasma in a plasma processing reactor, comprising:
determining the resonant frequencies of the plasma in the plasma processing reactor utilizing at least two probes;
determining the dielectric permittivity of the plasma at the locations of at least two probes using the resonant frequencies; and
determining the density of the plasma using the resonant frequencies at the locations of at least two probes.

34. The method of claim 33, wherein the determining of the resonant frequencies of the plasma in the plasma processing unit comprises:
providing radio frequency signals to the at least two probes;
receiving back reflected radio frequency signals which carry a plasma wave resonance signature;
reducing low frequency signals;
determining resonant frequencies for the at least two probes.

35. The method of claim 34, wherein the dielectric permittivity of the plasma is determined using the equation:
$$D ( ω , {k}_{z} , m ) = {ɛ}_{p} - {ɛ}_{d} \cdot \frac{{K}_{m} ( {k}_{z} a )}{{K}_{m}^{′} ( {k}_{z} a )} \cdot \frac{α {I}_{m}^{′} ( {k}_{z} a ) + β {K}_{m}^{′} ( {k}_{z} a )}{α {I}_{m} ( {k}_{z} a ) + β {K}_{m} ( {k}_{z} a )} = 0$$
where:
ω=2πf (where f is a wave frequency)
k_{z=2}π/λ (where k_{z} is a longitudinal wave vector; λ is a longitudinal wavelength)
m=azimuthal mode number
ε_{d}=dielectric permittivity of the dielectric cap 115
a=external radius of dielectric cap 115
b=internal radius of dielectric cap 115
Iₘ=modified Bessel function of first kind of order m
Kₘ=modified Bessel function of second kind of order m
Iₘ′ and Kₘ′ are derivatives, respectively, for Iₘ and Kₘ.
and
$$α = \frac{1}{{ɛ}_{d}} \cdot \frac{{sK}_{m} ( {k}_{z} b ) - p {ɛ}_{d} {K}_{m}^{′} ( {k}_{z} b )}{{K}_{m} ( {k}_{z} b ) {I}_{m}^{′} ( {k}_{z} b ) - {I}_{m} ( {k}_{z} b ) {K}_{m}^{′} ( {k}_{z} b )}$$
$$β = \frac{1}{{ɛ}_{d}} \cdot \frac{p {ɛ}_{ d} {I}_{m}^{′} ( {k}_{z} b ) - {sI}_{m} ( {k}_{z} b )}{{K}_{m} ( {k}_{z} b ) {I}_{m}^{′} ( {k}_{z} b ) - {I}_{m} ( {k}_{z} b ) {K}_{m}^{′} ( {k}_{z} b )}$$
where rₐ=radius of antenna tip

36. The method of claim 33, wherein the at least two probes are located within a substrate holder of the plasma processing reactor.

37. The method of claim 33, wherein the at least two probes are located on chamber walls of the plasma processing reactor.

38. The method of claim 33, wherein the at least two probes are located on a periphery of the substrate holder of the plasma processing reactor.

39. The method of claim 33, wherein the at least two probes are located symmetrically about the plasma processing reactor.

40. The method of claim 33, wherein information about local values of the plasma density is provided by the at least two probes and utilized to determine three dimensional plasma density distribution inside the plasma processing reactor.

41. The apparatus of claim 24, wherein a dielectric spacer is disposed inside the dielectric cap around the antenna tip to provide constancy of the space between the antenna tip and the dielectric cap.

42. The apparatus of claim 41, wherein the dielectric spacer is a ring or a tube.

43. The apparatus of claim 24, wherein a dielectric cap has a shape that becomes narrow at the end and effectively replaces the need for a dielectric spacer around the antenna tip thus ensuring the constancy of the antenna tip distance.

44. The apparatus of claim 1, wherein the dielectric cap is of a shape which limits cable expansion and provides a relatively constant distance between the antenna tip and the dielectric cap.

45. The method of claim 22, wherein the dielectric cap is of a shape which limits cable expansion and provides a relatively constant distance between the antenna tip and the dielectric cap.

46. The method of claim 33, wherein the dielectric cap is of a shape which limits cable expansion and provides a relatively constant distance between the antenna tip and the dielectric cap.

47. The apparatus of claim 44, wherein the corner of the coaxial cable abuts against the dielectric tube, and the antenna tip extends into a portion of the dielectric tube with reduced diameter.

48. The method of claim 45, wherein the corner of the coaxial cable abuts against the dielectric tube, and the antenna tip extends into a portion of the dielectric tube with reduced diameter.

49. The method of claim 46, wherein the corner of the coaxial cable abuts against the dielectric tube, and the antenna tip extends into a portion of the dielectric tube with reduced diameter.
